(19) United States
(12) Patent Application Publication
(10) Pub. No.: US 2003/0045285 A1
(43) Pub. Date: Mar. 6, 2003

(54) System and method for controlling data traffic flow to mobile platforms

(76) Inventor: David S. Parkman, Mercer Island, WA (US)

Correspondence Address: HARNESS, DICKEY & PIERCE, P.L.C., P.O. BOX 828, BLOOMFIELD HILLS, MI, 48303, US

(21) Appl. No.: 10/167,366

(22) Filed: Jun. 10, 2002

Related U.S. Application Data
(60) Provisional application No. 60/316,410, filed on Aug. 31, 2001.

(51) Int. Cl. H04Q 7/20

(52) U.S. Cl. 455/428

(57) ABSTRACT

A system and method for inserting data packets into unoccupied segments of a data stream to thereby reduce the amount of unused bandwidth when communicating data to mobile platforms using a satellite system. Non-priority data packets that are not time sensitive are inserted into data paths, wherein other data packets, including priority data packets, are already provided. Specific non-priority data packets are selected for insertion based upon specified characteristics. One or more transponded satellites are used for transmitting the data packets according to data traffic requirements to thereby maximize the use of available bandwidth.

### CROSS-REFERENCE TO RELATED APPLICATIONS

This application claims priority from U.S. provisional application serial No. 60/316,410, filed Aug. 31, 2001.

### FIELD OF THE INVENTION

The present invention relates generally to systems for controlling data traffic flow over an RF communications link, and more particularly to a system and method for distributing data packets within a data stream for transmission to a mobile platform via a satellite system.

### BACKGROUND OF THE INVENTION

Efficient use of bandwidth, and more particularly, maximizing use of allocated bandwidth in a radio frequency (RF) communications link is an important concern in the field of RF communications. The more bandwidth that is required to transmit data because of inefficiencies in distributing the available allocated bandwidth, the higher the cost of transmitting that data. Thus, decreasing the amount of unused available bandwidth is critical.

With the increased mobility of society, resulting not only from the availability and lower cost of faster transportation (e.g., discount on-line airline tickets), but from the increased availability of devices for accessing information while in-transit (e.g., laptop computers and Personal Digital Assistants (PDAs)), increasing numbers of individuals are demanding more bandwidth at the same time. With the demand for bandwidth increasing rapidly, not only is controlling bandwidth allocation crucial, but managing usage of the allocated bandwidth is virtually a necessity.

The available bandwidth may be limited by the electronic communication infrastructure and/or by the physical available space for communicating the electronic information. For example, with respect to satellite communications, the number of satellites in orbit has increased to the point that there is very limited air space for expansion, making it difficult to add new satellites in the existing orbit, without resulting in transmission interference problems. However, the demand for the existing bandwidth from these satellites has increased dramatically. For example, satellite communication is now used for many everyday electronic transmissions, including television broadcasting and wireless communication, the demand for which has increased at a high rate. As a result of the increasing demand and limited space, particularly with respect to satellite communication, the cost for using bandwidth is extremely high. In some cases the cost for bandwidth for satellite communication is 1000 times more than that for non-satellite communication.

Therefore, a need for efficiently controlling bandwidth usage, and more specifically, maximizing usage of allocated bandwidth has become increasingly important, particularly when communicating via a satellite link.

### SUMMARY OF THE INVENTION

The present invention provides a system and method for controlling data traffic flow, as well as increasing the efficiency of RF transmission of that data to one or more mobile platforms via a satellite communication system. The invention maximizes the use of available bandwidth by distributing different types of data within data streams according to the specific requirements for transmission to the mobile platform(s). Thus, depending upon the priority level of the data, the present invention controls the data traffic flow through transponders carried on the satellites in the satellite communication system. This may include controlling not only the type of data transmitted to the mobile platforms, but the time at which the data is transmitted.

Specifically, multicast data transmitted to a plurality of mobile platforms (e.g., a fleet of aircrafts) for accessing using a portal may include data having different levels of time sensitivity. That is, some data is more time sensitive to a user than other data. For example, data having lower time sensitivity may include data for updating movie or audio content to be stored on-board the mobile platform for future use. Another example of non-time sensitive data includes web-based data that is not dependent on time for accuracy (i.e., does not change frequently). Other data is time sensitive and may include, for example, web-based real-time data relating to breaking news and current weather or streaming media, as well as live television.

The present invention provides for inserting non-priority data packets (i.e., data that is not time sensitive) into a data stream for transmission to mobile platforms using satellite communication. Available data space within the data stream is identified and non-priority data packets are inserted for transmission along with other data packets, such as priority data packets. Thus, non-priority data packets awaiting transmission are inserted within the data traffic stream and occupy unused bandwidth, but only after priority data packets have been inserted. Priority data is transmitted upon a request for this data from a user on-board the mobile platform in order to maintain the real-time content accessed by the user.

Multiple transponders provided in connection with each satellite are used to transmit the data packets to the mobile platforms. The mobile platforms preferably include an on-board component for receiving and storing the non-priority data for access by users interfacing with a portal provided on-board the mobile platforms. Further, a remote component is preferably provided for receiving the priority data and allowing for real-time access of the content by interfacing with the portal using a user's computing device. This may also include a user requesting specific real-time content. Thus, not only is data provided for real-time access, but stored data may be dynamically updated using the same bandwidth by inserting non-priority data packets within the data stream not occupied by priority data packets.

The transmission bandwidth requirements of the transponders are determined by user demands on-board the mobile platforms, with data having lower time sensitivity transmitted when available bandwidth is identified and available. Thus, the present invention provides a system and method for background distribution of non-priority data packets within a data stream transmitted to a mobile platform using transponders of a satellite. More efficient use of available bandwidth via a satellite transponder is thereby achieved.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram showing transmissions from a plurality of orbiting satellites in which a system constructed according to the principles of the present invention may be implemented;

FIG. 2 is a perspective view of a satellite transmission coverage region;

FIG. 3 is a simplified plan view of a satellite;

FIG. 4 is a simplified block diagram of a system in which data packets may be inserted according to the present invention;

FIG. 5 is a simplified block diagram of a data stream transmitted by the present invention;

FIG. 6. is a simplified block diagram of a data stream having different types of data packets and an unoccupied segment;

FIG. 7 is a simplified block diagram of the data stream of FIG. 6 having a data packet inserted into the unoccupied segment according to the present invention; and

FIG. 8 is a flow chart showing the data insertion process of the present invention.

### DETAILED DESCRIPTION OF THE PREFERRED EMBODIMENTS

The following description of the preferred embodiments is merely exemplary in nature and is in no way intended to limit the invention, its application or uses. Thus, although the application of the present invention as disclosed herein is generally directed to an aircraft environment and controlling bandwidth through a transponder of a satellite, it is not so limited and other communication devices, such as transmission towers having transmission dishes thereon, may be used in connection with transmitting data to mobile platforms, such as trains, cruise ships, automobiles, buses, etc. according to the principles of the present invention.

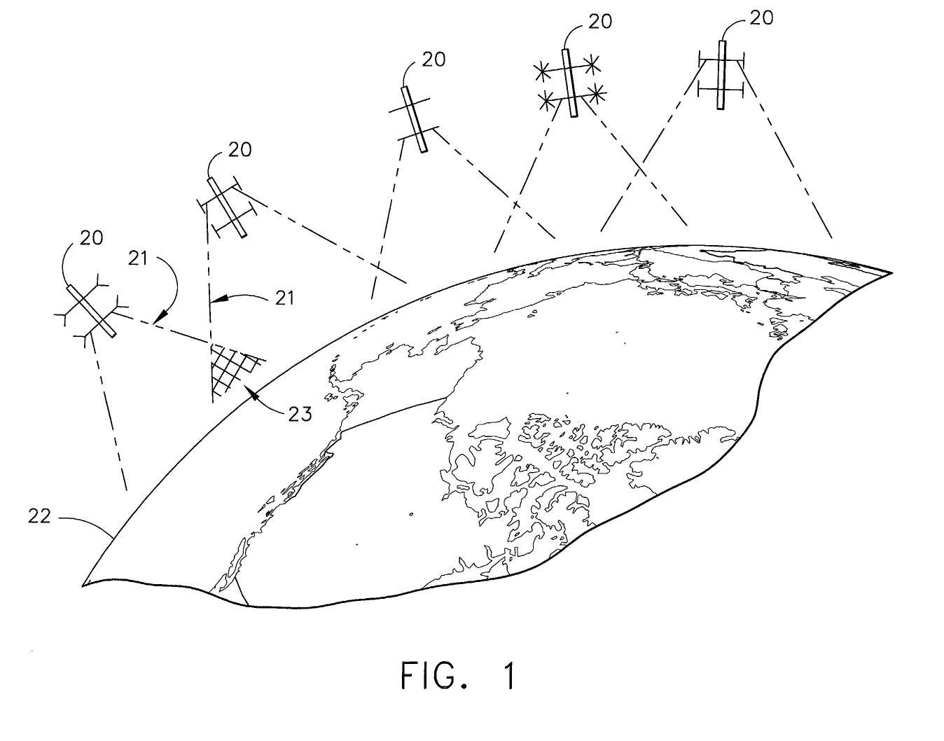

Referring to FIG. 1, a plurality of satellites 20 orbit the Earth 22 to provide communication around the world including, for example, satellites 20 that provide broadcast television, wireless telephone services and global positioning system (GPS) services. As shown therein, transmissions 21 from one satellite 20 and its adjacent satellite 20 are very limited in space and may result in some interference, represented by overlap region 23.

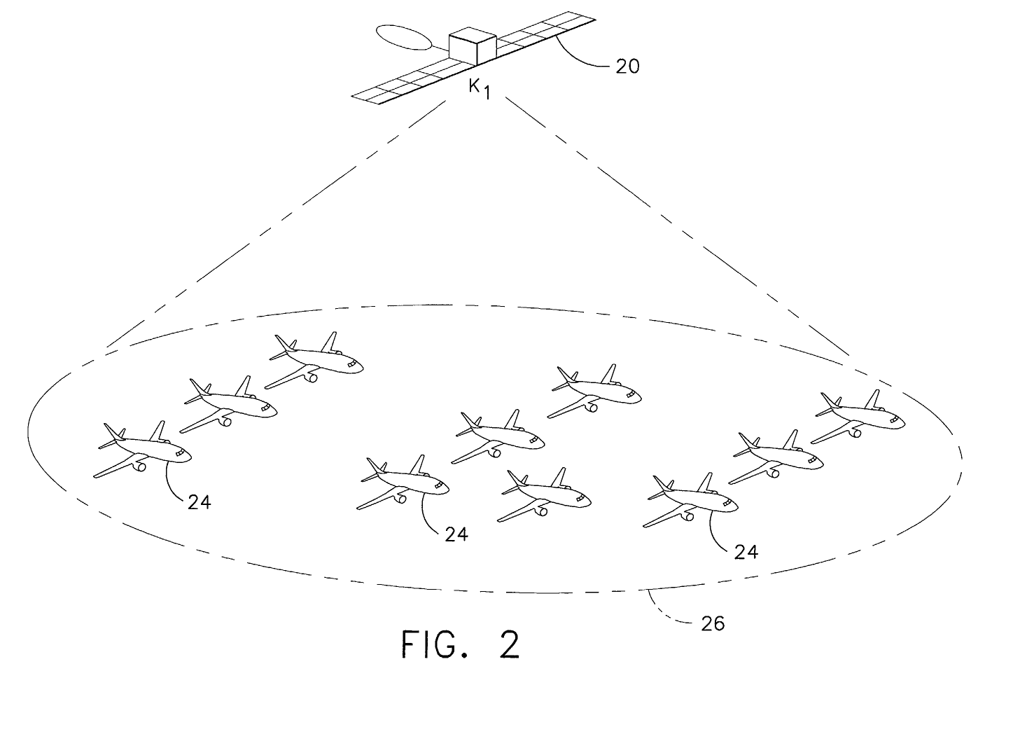

A system for transmitting data to a plurality of mobile platforms 24, illustrated as aircrafts, using at least one satellite 20 is shown in FIG. 2. The satellite 20 broadcasts signals having data packets to a transmission region 26. Mobile platforms 24 within the transmission region 26 that are adapted to receive the broadcast signal may obtain the transmitted data packets.

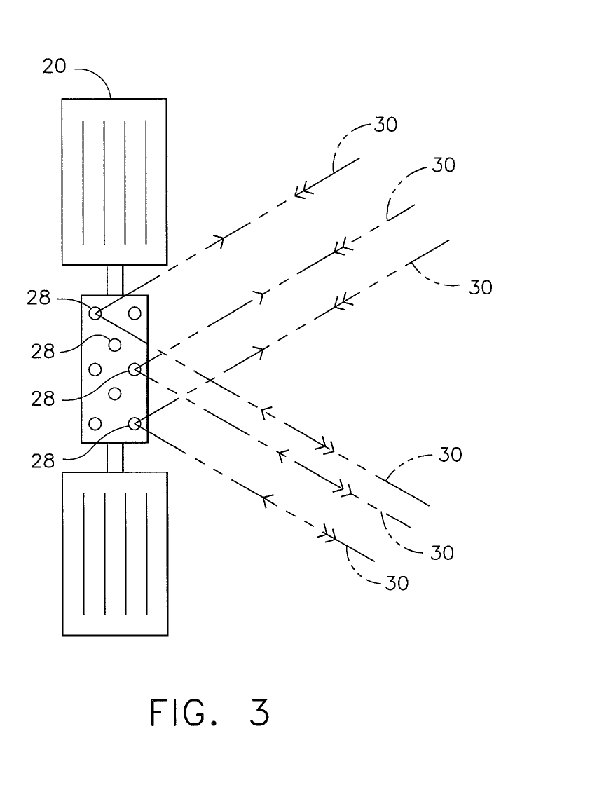

Each satellite 20 preferably includes a plurality of transponders 28, as shown in FIG. 3, for providing bi-directional communication between the mobile platforms 24 and a ground-based system 36. The transponders 28 facilitated multiple bi-directional data traffic paths. Specifically, a plurality of bi-directional data streams 30 are provided and include data configured as data packets.

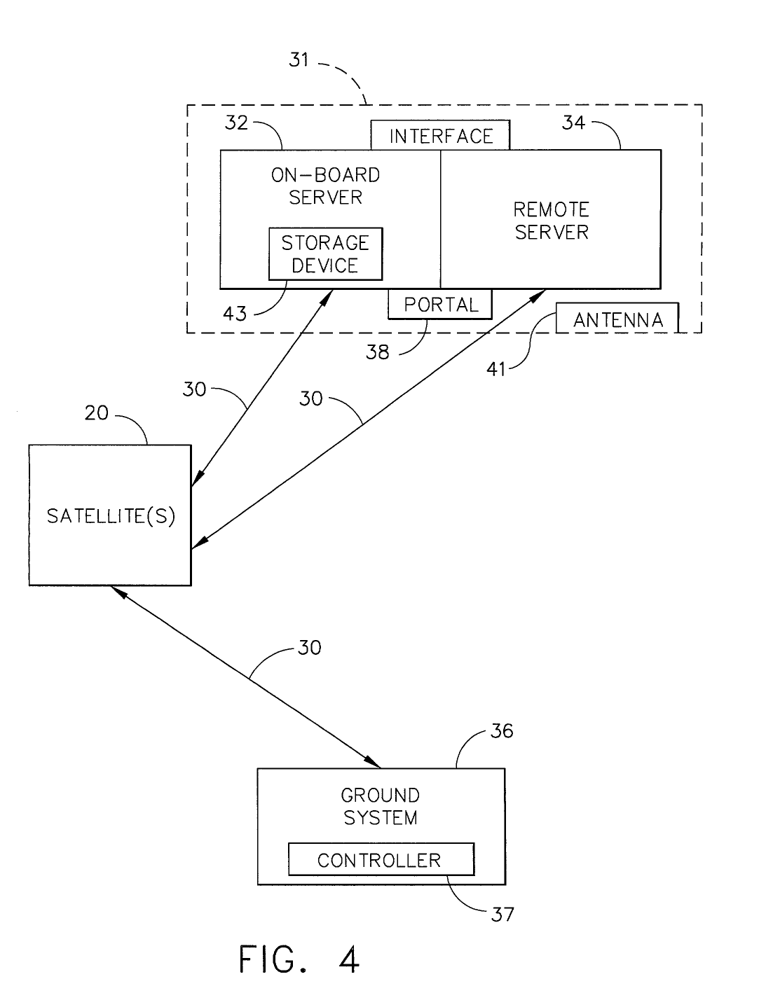

The mobile platforms 24 each include an on-board electronics system 31 for receiving and distributing the transmitted data packets. As shown in FIG. 4, an on-board server 32 is provided for storing data packets in a storage device 43 and routing data packets containing content that is not time sensitive. This content is transmitted in non-priority data packets. A remote server 34 is provided for routing data packets containing content that is time sensitive. This content is provided in priority data packets. It should be noted that the servers 32, 34 may be separate components of the same main server. The servers 32, 34 provide the data content via a portal 38 to users on-board the mobile platforms 24 accessing the portal with user devices such as laptops and PDAs.

Non-priority data packets include content such as, for example, destination city information (e.g., general city information, events information, hotel information, etc.), entertainment content (e.g., electronic games), stored media or audio content (e.g., movies or music), shopping content (e.g., cached catalogs) and stored news and business content (e.g., highlights of stories from the previous week). Priority data packets include content such as, for example, live broadcasting (e.g., live television programming), streaming media, real-time information (e.g., up-to-date sports scores, weather, stock market information) and real-time web-based content (e.g., links to real-time information or for use in “surfing” the World Wide Web).

Referring again to FIG. 4, the on-board server 32 and remote server 34 are in bidirectional communication with a ground-based system 36 via at least one of the satellites 20. An antenna 41 for receiving and transmitting data packets is also provided on-board the mobile platform 24. The ground based system includes a controller 37 for determining unoccupied data space and inserting data packets as described herein. Additional satellites 20 may be provided to expand the geographic coverage area within which the mobile platforms 24 can access real-time data from the ground-based system 36.

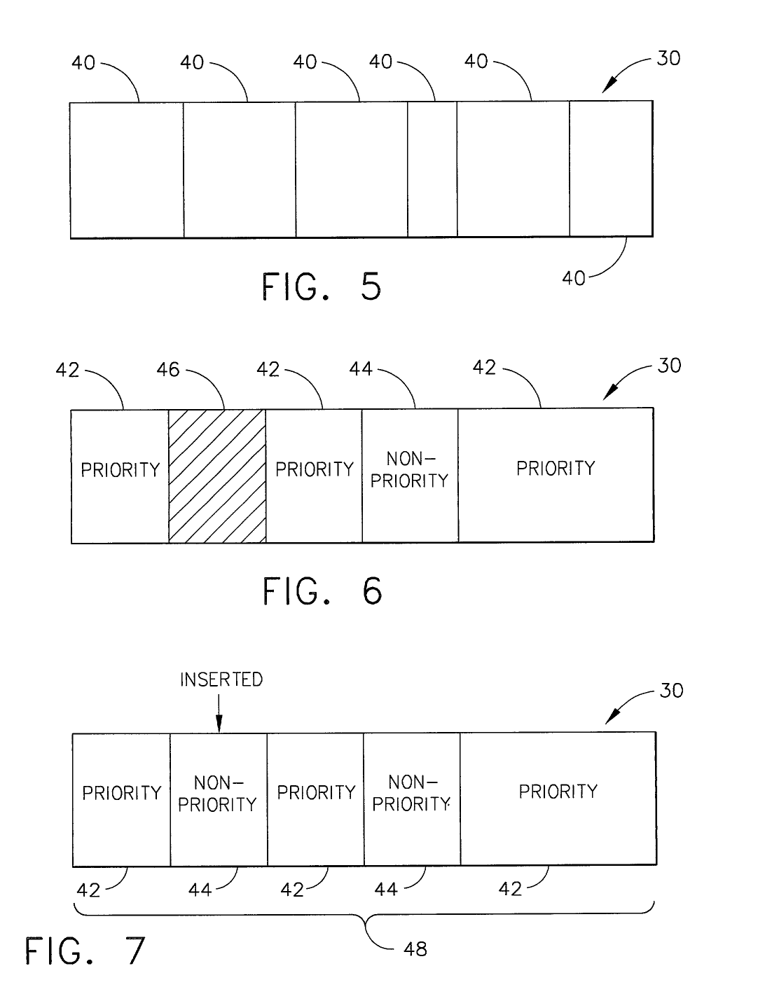

With respect to the bidirectional data streams 30, each stream preferably comprises a plurality of data packets 40 as shown in FIG. 5. These data packets 40 may vary in size depending upon the transfer requirements of the data. For example, the bandwidth requirements for real-time data such as streaming media and for other web-based content are different. The data streams 30 may include priority data packets 42 each having time sensitive content and non-priority data packets 44 having content that is not time sensitive as shown in FIG. 6. Included within the data streams 30 are typically segments that have no data packets. This unoccupied data space 46 represents valuable unused bandwidth.

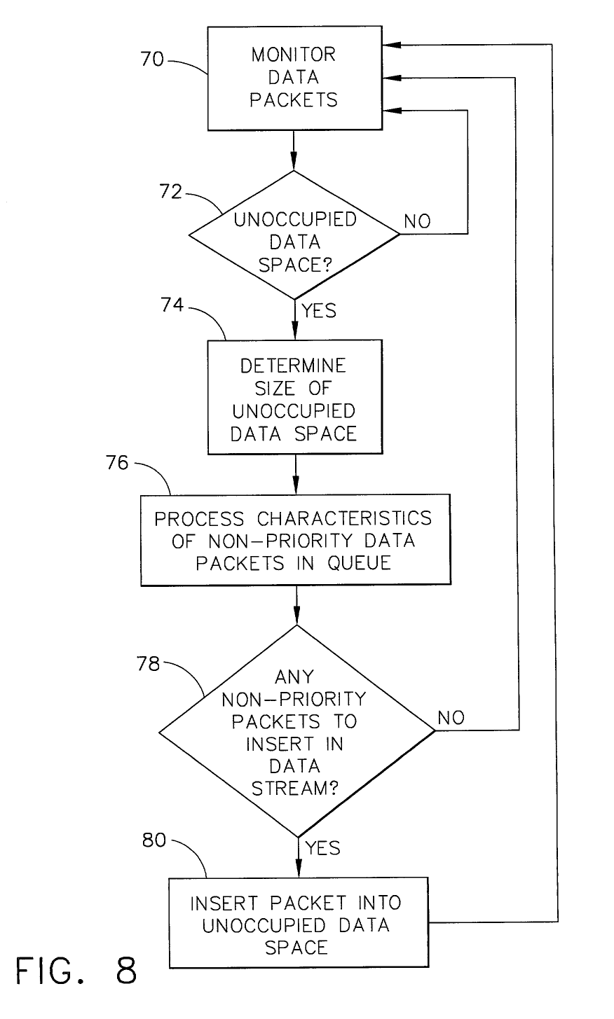

In a particularly preferred embodiment of the present invention as shown in flow chart form in FIG. 8, the data packets 40 of the data streams 30 are constantly monitored, as indicated at step 70, to identify unoccupied data space 46 (i.e., unused bandwidth), as indicated at step 72, prior to transmitting a portion 48 of the data stream 30 containing the unoccupied data space 46. The size of the unoccupied data space 46 is then determined, as indicated at step 74. It should be noted that all priority data packets 42 awaiting transmission have already been inserted within the portion 48.

A determination is then made as to which of the non-priority data packets 44 may be inserted within the unoccupied space 46. The specific characteristics of the awaiting non-priority data packets 44 are processed and determined, as indicated at step 76, to determine which, if any, of the non-priority data packet(s) 44 should be inserted within the unoccupied data space 46. The specific characteristics may include, for example, the size of the awaiting non-priority data packets 44, the length of time that an awaiting non-priority data packet 44 has been in a transmission queue, when the mobile platform 24 needs the non-priority data packet 44 and the type of non-priority data packet 44. The characteristics are processed based upon system requirements, such as which transponder 28 will be used to transmit the data packets 40 and the requirements of the on-board server 32 and remote server 34, such as if one stored movie is about to end and another one is scheduled to start immediately thereafter.

After the characteristics of the awaiting non-priority data packets 44 are processed and determined, a determination is made at step 78 as to whether any of the awaiting non-priority data packets 44 may be inserted into the data stream 30 based upon the characteristics of the awaiting non-priority data packets 44, the system requirements and data stream 30 allocated bandwidth limits. Any awaiting non-priority data packets 44 that meet the requirements for insertion are inserted within the data stream 30 at step 80, and as is shown in FIG. 7. This process is preferably repeated for each portion 48 of the data stream 30. In some instances all of the unoccupied data space 46 may not be completely used. For example, the awaiting non-priority data packets 44 selected for insertion may not have a size exactly equal to the unoccupied data space 46. However, the present invention attempts to maximize the use of the unoccupied data space based upon the characteristics of the non-priority data packets 44. It should be noted that the monitored portion 48 may include a predetermined number of data packets 40 or may be based upon a specified time frame depending upon system requirements. Monitoring of the data packets 40 and insertion of data packets 40 is provided in any suitable manner depending upon system requirements.

It should also be noted that when reference is made to inserting a data packet within a data stream, this refers to routing that specific data packet with the other data packets in that data stream to the specified destination. This may include routing different packets to different destinations by switching specific packets during transmission. Thus, with respect to the mobile platform example described herein, data packets may be routed to a single mobile platform, or even a specific device within the mobile platform, or may be routed to a plurality of mobile platforms.

It should be further noted that the present invention may be implemented within software or hardware depending upon the particular system requirements. The software or hardware may provide control of the data streams from different component parts of the system as is required.

Although the present invention is described in connection with mobile platforms 24 communicating with a ground-based system 36 through bi-directional data streams 30 via one or more satellites 20, it should be appreciated that different or additional components may be provided as part of the mobile platform 24, the ground system 36 and the satellite system 38. This may include, for example, different satellite systems and data path configurations. Thus, the control of data traffic by identifying and using unused bandwidth by inserting data packets into available bandwidth may be provided in connection with other systems that are implemented and configured according to the requirements of the particular mobile platforms.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A communication system for controlling the transmission of data to at least one mobile platform for access via a portal located on the mobile platform, the data being configured as data packets in a bidirectional data stream and having priority and non-priority data packets, the communication system comprising:
a satellite having at least one transponder for receiving the priority and non-priority data packets and for transmitting the data packets to the mobile platform for access via the portal; and
a controller for determining unoccupied data space within the data stream and inserting non-priority data packets into the unoccupied data space to be transmitted to the mobile, platform via the satellite when no priority data packets are awaiting transmission.

2. The communication system according to claim 1 wherein the satellite operates to multicast the data packets to a plurality of mobile platforms using the at least one transponder.

3. The communication system according to claim 2 wherein the mobile platforms comprise aircrafts; and
further comprising at least one antenna connected to each aircraft for receiving the multicast data packets.

4. The communication system according to claim 1 wherein the non-priority data packets comprise updated data; and
further comprising a storage device on-board the at least one mobile platform for storing the updated data for access using the portal.

5. The communication system according to claim 1 wherein the priority data comprises real-time data; and
further comprising an interface on-board the at least one mobile platform for accessing the real-time data using the portal.

6. The communication system according to claim 1 wherein the data comprises web-based content; and
further comprising an interface on-board the at least one mobile platform for accessing the web-based content from a user device using the portal.

7. The communication system according to claim 1 wherein the controller operates to monitor and identify unoccupied data space within the data stream for inserting the non-priority data packets for transmission by the satellite.

8. The communication system according to claim 1 wherein the data transfer rate of the at least one transponder is configured based upon user data stream requirements.

9. A method for maximizing bandwidth usage when transmitting data packets within a data stream to at least one mobile platform for access using a portal on the mobile platform, the data packets including non-priority and priority data packets, the method comprising the steps of:
using at least one transponder of a satellite to transmit the data packets to the mobile platform; and
using a controller to insert non-priority data packets within the data stream for transmitting to the mobile platform using available bandwidth when no priority data packets are awaiting transmission.

10. The method according to claim 9 wherein the priority data packets are time sensitive; and
further comprising transmitting the priority data packets upon a request from the mobile platform before the non-priority data packets.

11. The method according to claim 9 wherein the non-priority data packets are not time sensitive; and
further comprising storing the non-priority data packets on-board the mobile platform.

12. The method according to claim 9 wherein the data packets contain web-based content; and
further comprising accessing the web-based content via the portal using an interface on-board the mobile platform.

13. The method according to claim 9 wherein the mobile platform comprises an aircraft and the step of using the at least one transponder further comprises multicasting the data packets to a plurality of aircrafts.

14. The method according to claim 9 further comprising the step of identifying available data space within the data stream for inserting non-priority data packets.

15. The method according to claim 14 further comprising determining the characteristics of the non-priority data packets to maximize the use of the identified available data space.

16. The method according to claim 9 further comprising configuring the bandwidth rate of the at least one transponder based upon the data stream requirements of users on-board the mobile platform.

17. A method for controlling data traffic configured as data packets within a data stream, the data packets including both priority and non-priority data packets configured for transmission to at least one mobile platform having an on-board portal for accessing the data, the method comprising the steps of:
monitoring the data stream to identify available data space within the data stream not occupied by data packets, the data packets within the data stream including at least all of the priority data packets awaiting transmission;
determining the size of the available data space within the data stream;
determining the characteristics of non-priority data packets awaiting transmission; and
inserting non-priority data packets with characteristics satisfying specified parameters within the available data space for transmitting to the at least one mobile platform.

18. The method according to claim 17 further comprising the step of using at least one transponder of a satellite for transmitting the data packets.

19. The method according to claim 17 further comprising the step of transmitting the priority data packets upon a request from the mobile platform.

20. The method according to claim 17 further comprising storing non-priority data packets on-board the mobile platform for access using the portal.
